(19) United States
(12) Patent Application Publication
(10) Pub. No.: US 2024/0195659 A1
(43) Pub. Date: Jun. 13, 2024

(54) MODULATING TONES IN A LONG TRAINING FIELD

(71) Applicant: MaxLinear, Inc., Carlsbad, CA (US)

(72) Inventor: Sigurd Schelstraete, Menlo Park, CA (US)

(73) Assignee: MaxLinear, Inc., Carlsbad, CA (US)

(21) Appl. No.: 18/536,180

(22) Filed: Dec. 11, 2023

Related U.S. Application Data
(60) Provisional application No. 63/386,840, filed on Dec. 9, 2022.

(51) Int. Cl. H04L 25/02

(52) U.S. Cl. CPC H04L 25/0224; H04W 84/12

(57) ABSTRACT

A method includes obtaining a transmission to be transmitted via a transmission channel. The method also includes identifying at least one symbol included in the transmission. The at least one symbol may include multiple tones. The method further includes performing a first modulation to a first subset of the multiple tones. The method also includes performing a second modulation to a second subset of the multiple tones.

### CROSS REFERENCE TO RELATED APPLICATIONS

This U.S. patent application claims priority to U.S. Provisional Patent Application No. 63/386,840, titled “EXTREMELY HIGH THROUGHPUT (EHT)-LONG TRAINING FIELD (LTF) (EHT-LTF) FOR TRAINING AND DATA TRANSMISSION,” and filed on Dec. 9, 2022, the disclosure of which is hereby incorporated by reference in its entirety.

### TECHNICAL FIELD

This disclosure generally relates to wireless communication, and more specifically, to modulating tones in a long training field.

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining a transmission to be transmitted via a transmission channel. The method may also include identifying at least one symbol included in the transmission. The at least one symbol may include multiple tones. The method may further include performing a first modulation to a first subset of the multiple tones. The method may also include performing a second modulation to a second subset of the multiple tones.

In another embodiment, a method may include obtaining a transmission transmitted from a transmitting device via a transmission channel. The method may also include identifying at least one symbol included in the transmission. The at least one symbol may include multiple tones. The method may further include determining a first channel estimation associated with a first subset of the plurality of tones. The method may also include determining a second channel estimation associated with a second subset of the plurality of tones in view of the first channel estimation. The method may also include obtaining data associated with the second subset of the plurality of tones using the second channel estimation.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates an example wireless communication system that may be operable to modulate tones in a long training field (LTF);

FIG. 2 illustrates an example training signal for an LTF;

FIG. 3 illustrates a flowchart of an example method of transmitting an LTF having modulated tones;

FIG. 4 illustrates a flowchart of an example method of receiving an LTF having modulated tones; and

FIG. 5 illustrates a diagrammatic representation of a machine in the example form of a computing device implementing modulation of tones in an LTF.

### DETAILED DESCRIPTION

An extremely high throughput (EHT) transmission (e.g., an IEEE 802.11be transmission) may include a preamble that contains extremely high throughput-long training field (EHT-LTF) symbols, where the data tones of each EHT-LTF symbol may be multiplied by entries belonging to a matrix, to enable channel estimation at a receiver. When single stream pilot is used in EHT-LTF, the pilot subcarriers of each EHT-LTF symbol may be multiplied by the entries of a matrix to allow receivers to track phase and/or frequency offset during MIMO channel estimation using the EHT-LTF.

Subcarrier spacing in IEEE 802.11ax and IEEE 802.11be is 78.125 kHz, which is a quarter of the 312.5 kHz tone spacing that was used in earlier generations of Wi-Fi. A motivation for the change in tone spacing was the desire to have longer orthogonal frequency-division multiplexing (OFDM) symbols. Longer OFDM symbols may reduce the relative overhead of a Guard Interval (GI) and may allow for about 10% gain in efficiency. Other advantages may include the absolute length of the GI may be increased without affecting the relative overhead, which may help with aligning multi user transmissions and may be useful for communications in highly dispersive channels.

With the data symbols now four times longer than in prior generations of Wi-Fi, the duration of the high efficiency (HE)/EHT-LTF training symbols increases proportionally. Each HE/EHT-LTF symbol now also takes four times longer (e.g., compared to very high throughput (VHT)-LTF or high throughput (HT)-LTF). As such, in view of the reduction in tone spacing, the duration of the HE/EHT-LTF symbols may also be reduced, such that IEEE 802.11ac and/or IEEE 802.11be may support half symbol duration and/or quarter symbol duration. In the present disclosure, a full symbol duration may be referred to as 4×LTF or 4×HE/EHT-LTF, a half symbol duration may be referred to as 2×LTF or 2×HE/EHT-LTF, and a quarter symbol duration may be referred to as 1×LTF or 1×HE/EHT-LTF.

Some prior approaches may use shortened HE/EHT-LTF symbol durations for channel estimation as interpolation between the HE/EHT-LTF symbols may accomplish the channel estimation. In some instances, the prior approaches may limit the number of transmitted HE/EHT-LTF symbols at the expense of including additional information in the HE/EHT-LTF symbols and/or preamble portion of a transmission.

Some aspects of the present disclosure may resolve at least some of the shortcomings or alternative implementations of the prior approaches by modulating portions of the tones included in the HE/EHT-LTF symbols to include data, such that additional data may be included in each transmitted HE/EHT-LTF symbol while still providing ample tones for a receiving device to perform a channel estimation. As such, according to some aspects of the present disclosure, a preamble associated with a transmission between a transmitting device and a receiving device may include more preamble content as a portion of the tones may be modulated to include additional preamble data (e.g., while another portion of the tones may retain the signaling characteristics to accomplish a channel estimation as needed) without affecting the quality of the channel estimate compared to 2×HE/EHT-LTF and/or 1×LTF or 1×HE/EHT-LTF symbol durations. Alternatively, or additionally, the preamble according to some aspects of the present disclosure may experience a modest increase in length (e.g., approximately eight microseconds per HE/EHT-LTF symbol) to accommodate data transmission therein in addition to the HE/EHT-LTF symbols used for channel estimation. In another aspect, communications between a transmitting device and a receiving device may be shortened as data may be modulated into the tones of the HE/EHT-LTF symbols such that no distinct data field may be needed as part of the transmission.

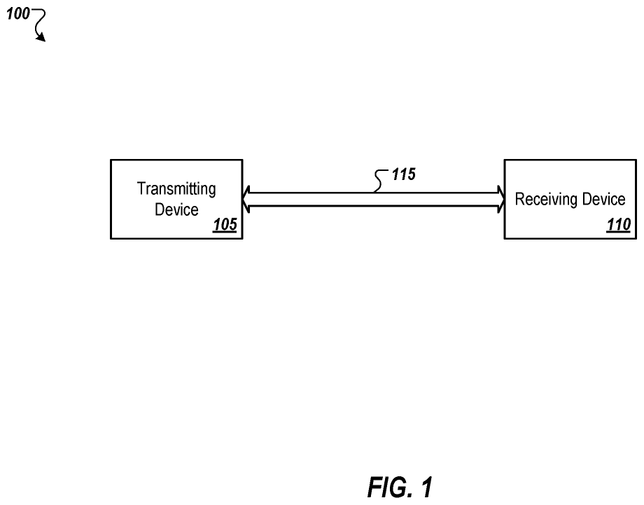

FIG. 1 illustrates an example wireless communication system 100 (“system 100”) that may be operable to modulate tones in a long training field (LTF), in accordance with at least one embodiment of the present disclosure. The system 100 may include a transmitting device 105, a receiving device 110, and a transmission channel 115.

The system 100 may be operable to perform wireless transmissions between at least the transmitting device 105 and the receiving device 110, such as via the transmission channel 115. The system 100 may be capable of implementing and/or using the Institute of Electrical and Electronics Engineers (IEEE) 802.11 protocols, such as IEEE 802.11be (which may be referred to as Extremely High Throughput (EHT) and/or Wi-Fi 7). The system 100 may support tone (e.g., subcarrier) spacing in transmissions that may be shorter relative to previous generations of IEEE 802.11, such as IEEE 802.11ac and/or earlier generations. For example, the tone spacing in IEEE 802.11be may be approximately 78.125 kHz, while the tone spacing in IEEE 802.11ac may be approximately 312.5 kHz.

The transmitting device 105 may include any device operable to modulate and/or transmit data within the system 100. For example, the transmitting device 105 may include a router, an access point, and/or other devices. The receiving device 110 may include any device operable to receive transmitted data within the system 100. For example, the receiving device 110 may include a consumer device (e.g., a mobile phone, a laptop computer, etc.), an access point (e.g., receiving from a router device), and/or other devices. Although referred to as the transmitting device 105 and the receiving device 110, it is understood that other operations may be performed by the devices, such as receiving (by the transmitting device 105) and transmitting (by the receiving device 110), respectively.

The transmission channel 115 may be a wireless medium for facilitating the transmission of transmissions from the transmitting device 105 to the receiving device 110. In the present disclosure, the term “transmission” or “packet(s)” may include various elements that may be grouped and/or transmitted from the transmitting device 105 to the receiving device 110. For example, a transmission (or a packet) may include data/data packets, symbols, training field information, etc. The transmission channel 115 may support various frequency bands as part of a transmission, such as 2.4 GHz, 5 GHz, 6 GHZ, and so forth, where each frequency band may include one or more channels disposed therein.

The transmission channel 115 may include channel state information that may describe one or more properties associated with the transmission channel 115 and/or the transmission of the packets via the transmission channel 115. The channel state information may include, but not be limited to, scattering, fading, power decay relative to distance, noise and an associated noise effect, and/or other characteristics that may affect the propagation of a signal (e.g., a signal transporting the packets) from the transmitting device 105 to the receiving device 110.

The transmitting device 105 may be operable to obtain one or more packets to be transmitted to the receiving device 110, such as via the transmission channel 115. For example, the transmitting device 105 may obtain a stream of packets (e.g., data) to transmit and the transmitting device 105 may perform one or more operations to the packets to prepare the packets for transmission. In the present disclosure, the transmitting device 105 may include one or more components therein that may individually perform operations that may collectively be referred to as performed by the transmitting device 105, unless specifically noted. For example, the transmitting device 105 may include a first component to receive the packets, a second components identify various aspects of the packets, a third component to perform a modulation to the packets, and so forth, all collectively referred to as performed by the transmitting device 105.

The transmitting device 105 may identify one or more symbols included individually in the packets, where the symbols may encode data and/or be operable to be used in training the receiving device 110. For example, IEEE 802.11 protocols may designate a portion of a packet frame to include an LTF. In instances in which the packet is part of the IEEE 802.11be protocol, the IEEE 802.11be protocols may designate the packets to include high efficiency (HE) extremely high throughput (EHT) LTF (HE/EHT-LTF) symbols.

The HE/EHT-LTF symbols may include one or more tones that may carry data and/or training information from the transmitting device 105 to the receiving device 110 by way of the packet transmitted in the transmission channel 115. In some instances, in response to the change in tone spacing (e.g., where the tone spacing associated with IEEE 802.11be is approximately one quarter of the tone spacing associated with IEEE 802.11ac), the duration of transmitted symbols (e.g., the HE/EHT-LTF symbols) may be reduced without causing an equivalent loss in performance, such as by the receiving device 110 receiving the packets from the transmitting device 105 and/or the receiving device 110 determining a channel estimation using the received packets. For example, IEEE 802.11be may support 4×LTF (e.g., full symbol duration), 2×LTF (e.g., half symbol duration), and/or 1×LTF (e.g., quarter symbol duration), where the IEEE 802.11be HE/EHT-LTF symbols may be shorter and/or may include a more coarse granularity relative to the IEEE 802.11ac symbols.

In response to the reduction of the symbol duration (e.g., the symbol duration associated with the HE/EHT-LTF symbols), the transmitting device 105 may perform modulations to the tones included in the HE/EHT-LTF symbols, such that a first portion of the tones may be modulated to carry a training signal and a second portion of the tones may be modulated to carry data. For example, the even tones included in the symbol may have a first modulation that may be a scaling factor and/or a training matrix, and the odd tones included in the symbol may have a second modulation that may include a digital modulation.

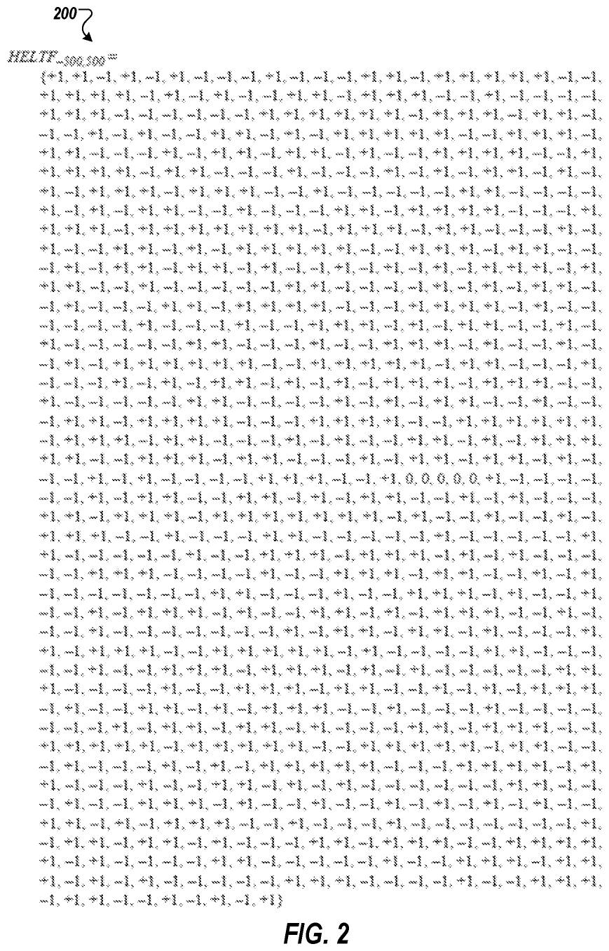

As described, the first modulation (e.g., to a first portion of the tones, such as the even tones) may be a scaling factor and/or a phase modulation, which may include the value of positive or negative one (e.g., each even tone included in the symbol retains its value and/or includes a phase adjustment). Alternatively, or additionally, the scaling factor may include a training signal, such as the training signal 200 illustrated in FIG. 2. As illustrated, the training signal 200, represented as a matrix, may include a sequence of values (e.g., +1 and 0), that may appear to be a pseudo-random sequence of values. Modulating the even tones in the symbol using the training signal 200 may enable the receiving device 110 to perform a channel estimation using the training data associated with the even tones of the symbol (e.g., upon reception of the packet from the transmitting device 105).

In some embodiments, the training signal (e.g., such as the training signal 200) may be associated with a particular bandwidth that may be associated with the packet and/or the transmission of the packet by the transmitting device. For example, the training signal 200 may be an HE/EHT-LTF training signal for an 80 MHz bandwidth. Other training signals may be implemented that may be associated with other bandwidths used as part of a packet transmission from the transmitting device 105 to the receiving device 110. For example, the bandwidths may include contiguous channels such as 160 MHz and 320 MHz, and/or non-contiguous channels such as 80+80 MHz and 160+80 MHz channels and various training signals may be utilized for the bandwidths having contiguous and/or non-contiguous channels.

The second modulation (e.g., to a second portion of the tones, such as the odd tones) may be a digital modulation that may be applied to the odd tones. The odd tones may be modulated to include data to be transmitted from the transmitting device 105 to the receiving device 110. As such, more information may be communicated from the transmitting device 105 to the receiving device 110 in various applications of the present disclosure. For example, in a first application, the amount of information that may be included in the preamble may be limited. For example, the universal signal field (U-SIG) for EHT packet frames may carry 42 bits of information and the HE/EHT-LTF for the 80 MHz bandwidth may include 996 tones. In instances in which half of the tones are modulated and assuming a coding rate of R=½, approximately 250 bits may be available to carry information, per HE/EHT-LTF symbol. In such instances, the bits may be used for preamble signaling, which may allow for more data to be included in the preamble (e.g., richer preamble content), which may introduce a modest increase in preamble length (e.g., approximately eight microseconds per HE/EHT-LTF symbol) to accommodate data transmission therein and/or may not noticeably affect the quality of the channel estimate.

In a second application, the extra bits (e.g., as described above) may be modulated to include data that may be the communication from the transmitting device 105 to the receiving device 110. For example, in instances in which a small amount of data (e.g., a couple of bytes) is to be transmitted from the transmitting device 105 to the receiving device 110, the data may be modulated on the tones of the HE/EHT-LTF symbols such that no data field may be included in the transmission (e.g., the payload of the message may be included in the HE/EHT-LTF symbols, thus reducing the amount of transmitted data and/or reducing the number of transmissions in the communication system).

In some embodiments, the second modulation may be a binary phase shift key (BPSK) modulation. Alternatively, or additionally, the second modulation may be other forms of digital modulation, such as but not limited to quadrature phase-shift key (QPSK) modulation, differential phase-shift key (DPSK) modulation, quadrature amplitude modulation (QAM), phase-shift key (PSK) modulation, frequency-shift key (FSK) modulation, and/or other number of phase shift key modulation (e.g., 8-PSK).

The modulation scheme for the amplitude of the tones included in the symbols may be represented as:

$${α}_{k} = \{ \begin{matrix}1 & when k is even \\ {Q}_{k} & when k is odd\end{matrix}$$

where αₖ may be the amplitude of the k^{th} tone in the symbol and Qₖ may be the digital modulation applied to the odd k^{th} tones, such as BPSK. As such, the tones may include a positive or negative one (e.g., ±1) adjustment, which may represent a phase modulation to the tones. In some instances, the digital modulation (Qₖ) may include data modulated into the tones, as described herein. For example, the data may be associated with a preamble in a transmission between the transmitting device 105 and the receiving device 110, where the data may enrich the preamble to include additional content. The additional content may include customer proprietary information, future standard requirements, and/or other information. In another example, the data may be a data payload (e.g., in instances in which a small amount of data may be transmitted, such as a couple of bytes), such that a typical data field in a transmission may not be included in a transmission.

In some instances, channel conditions may cause difficulty in the receiving device 110 performing an interpolation (as described herein) and/or receiving the data from the modulated tones. For example, deed fading in a wireless channel may cause unexpected noise, such that the receiving device 110 may have difficulty obtaining a channel estimate and/or obtaining the data from the modulated tones (e.g., including by interpolation). In some instances, the transmitting device 105 may be operable to perform a coding operation and/or an interleaving operation to the data prior to the data being mapped to the modulated tones. In instances in which the data is coded and/or interleaved, the receiving device 110 may be operable to perform a de-interleaving operation, which may spread out any errors that may be introduced due to the noisy channel. In such instances, the receiving device 110 may have a higher chance of recovering the data relative to instances in which the data is not coded and/or interleaved.

The transmitting device 105 may be operable to transmit the packet, which may include the symbol and/or the modulated tones therein, to the receiving device 110 via the transmission channel 115. The receiving device 110 may be operable to receive the transmitted packet and use the HE/EHT-LTF symbol(s) to perform a channel estimation and/or to obtain data included in the HE/EHT-LTF symbol(s) in the packets (e.g., the packet stream), as described herein.

The receiving device 110 may be operable to obtain the transmitted packet (which may be one or more packets included in the packet stream) from the transmitting device 105 via the transmission channel 115. The receiving device 110 may identify the HE/EHT-LTF symbol(s) in the transmitted packets, and/or the tones included in the HE/EHT-LTF symbols, as described herein.

The tones included in the HE/EHT-LTF symbols received by the receiving device 110 may be used to determine channel state information. In some instances, the channel estimated directly on the received tones may be represented by:

$${\tilde{H}}_{k} \{ \begin{matrix}{H}_{k} & when k is even \\ {H}_{k} {Q}_{k} & when k is odd\end{matrix}$$

where Hₖ may be an over-the-air channel for the k^{th} tone, and Qₖ may be the digital modulation applied to the odd k^{th} tones by the transmitting device 105 (which may be unknown to the receiving device 110).

The receiving device 110 may be operable to determine a first channel estimation associated with a first subset of the tones, where the first subset of the tones (e.g., the even tones) may have been modulated by the transmitting device 105 for training the receiving device 110 to obtain channel state information to use in a channel estimation operation. For example, the even tones (e.g., which may have been modulated by the transmitting device 105 using a scaling factor, such as the value one) may be used to determine a channel estimation for each of the even tones. The first channel estimation may be obtained by using the even tones:

\tilde{H}₂ₖ≅H₂ₖ

where H₂ₖ may be the over-the-air channel for the k^{th} even tones, and \tilde{H}₂ₖ may be the channel estimation for each of the k^{th} even tones. The even tones may be obtained from the HE/EHT-LTF symbols.

The receiving device 110 may be operable to determine a second channel estimation associated with a second subset of the tones. In some instances, the second channel estimation associated with the second subset of the tones may be determined by interpolating the values obtained for the first subset of the tones. The second subset of the tones may be the odd tones that may be obtained using interpolation of the even tones, such as by:

$${\hat{H}}_{2 k + 1} = \frac{{\tilde{H}}_{2 k} + {\tilde{H}}_{2 k + 2}}{2}$$

where Ĥ₂ₖ₊₁ may be the channel estimation for the k^{th} odd tones, and \tilde{H}₂ₖ and \tilde{H}₂ₖ₊₂ may be the over-the-air channels for two different k^{th} even tones. In some instances, all of the tones may be transmitted, where a portion of the tones may be used for channel estimation and another portion of the tones may be used to transmit other data, as described herein. Depending on the symbol duration, the number of available tones for channel estimation may vary. For example, 4×HE/EHT-LTF symbols (e.g., the full duration symbols) with modulation (as described herein) may have an equivalent number of tones available for channel estimation relative to 2×HE/EHT-LTF symbols (e.g., the half duration symbols) without modulation. In another example, 2×HE/EHT-LTF symbols with modulation may have an equivalent number of tones available for channel estimation relative to 1×HE/EHT-LTF symbols (e.g., the quarter duration symbols) without modulation.

Using the received second subset of tones (e.g., the received odd tones (H₂ₖ₊₁), obtained by interpolation), the second channel estimation may be obtained directly from the received tones (e.g., not through interpolation). The second channel estimation may be represented by:

\tilde{H}₂ₖ₊₁≅H₂ₖ₊₁Q₂ₖ₊₁

where \tilde{H}₂ₖ₊₁ may be the channel estimation for each of the k^{th} odd tones and H₂ₖ₊₁ may be the over-the-air channel for the k^{th} odd tones (as determined using interpolation and described herein), and Q₂ₖ₊₁ may be the digital modulation applied to the odd k^{th} tones.

An estimate of the digital modulation applied to the odd tones may be obtained by dividing the direct channel estimation for each of the k^{th} odd tones and the interpolated over-the-air channel for the k^{th} odd tones, which may be represented by:

$${\hat{Q}}_{2 k + 1} ≅ \frac{{\tilde{H}}_{2 k + 1}}{{\hat{H}}_{2 k + 1}}$$

The estimate of the digital modulation (e.g., \hat{Q}₂ₖ₊₁ above) may be a recovered signal and/or data transmitted by the transmitting device 105 to the receiving device 110. As such, according to aspects of the present disclosure, the HE/EHT-LTF symbols included in the transmitted packets may be used to convey data and/or training symbols (e.g., channel state information) between the transmitting device 105 and the receiving device 110, as opposed to only training symbols that may be used for channel estimation.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

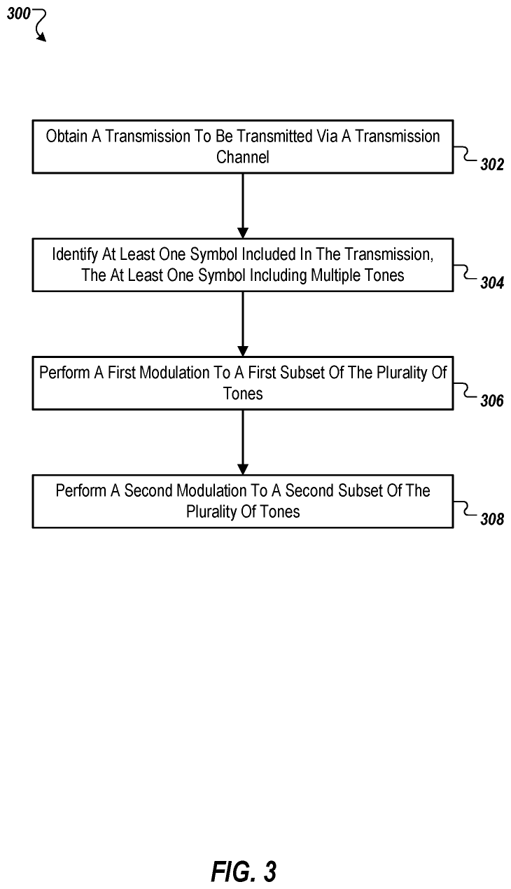

FIG. 3 illustrates a flowchart of an example method 300 of transmitting an LTF having modulated tones, in accordance with at least one embodiment of the present disclosure.

At block 302, a transmission to be transmitted via a transmission channel may be obtained. In some embodiments, the transmission may conform to Institute of Electrical and Electronics Engineers (IEEE) 802.11 protocols, such as IEEE 802.11be.

At block 304, at least one symbol included in the transmission may be identified. The at least one symbol may include multiple tones. In some embodiments, the at least one symbol may be a high efficiency/extremely high throughput-long training field (HE/EHT-LTF) symbol. The at least one symbol may be operable to facilitate a channel estimation associated with the transmission channel by a receiving device such as by using the first subset of the plurality of tones.

At block 306, a first modulation may be performed to a first subset of the multiple tones. In some embodiments, the first modulation comprises applying a scaling factor and/or a phase factor to the first subset of the plurality of tones. The scaling factor may include a training signal, and the training signal may include multiple values that may be associated with a particular bandwidth associated with the transmission.

At block 308, a second modulation may be performed to a second subset of the multiple tones. In some embodiments, the second modulation may include modulating the second subset of the multiple tones with data to be transmitted to a receiving device. The second modulation may be a binary phase shift key applied to the second subset of the plurality of tones. In some embodiments, the data may be included in a preamble of the transmission. For example, the data in the preamble of the transmission may be in lieu of including additional data in a data field of the transmission.

Modifications, additions, or omissions may be made to the method 300 without departing from the scope of the present disclosure. For example, the packet may be transmitted to a receiving device using the transmission channel.

In another example, the designations of different elements in the manner described is meant to help explain concepts described herein and is not limiting. Further, the method 300 may include any number of other elements or may be implemented within other systems or contexts than those described.

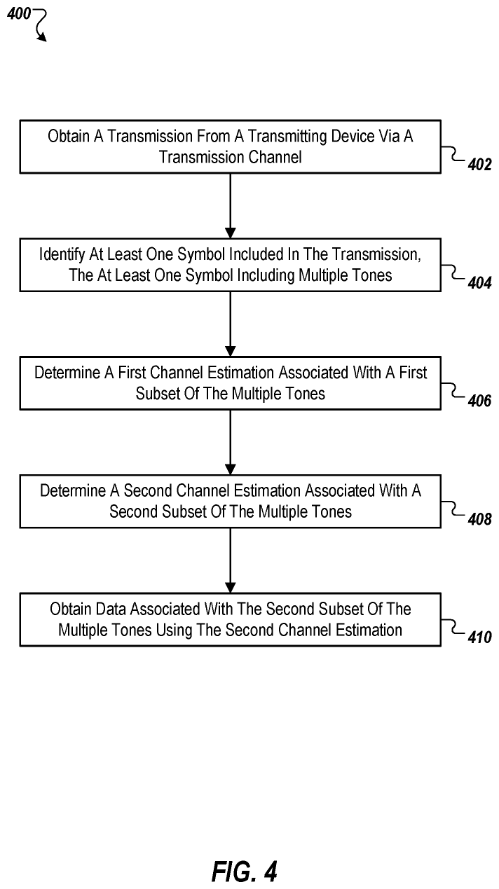

FIG. 4 illustrates a flowchart of an example method 400 of receiving an LTF having modulated tones, in accordance with at least one embodiment of the present disclosure. The method 300 and/or the method 400 may be performed by processing logic that may include hardware (circuitry, dedicated logic, etc.), software (such as is run on a general purpose computer system or a dedicated machine), or a combination of both, which processing logic may be included in any computer system or device, such as the transmitting device 105 and/or the receiving device 110 of FIG. 1. The implementation can also be on Application Specific Integrated Circuit (ASIC) or Programmable Hardware Devices (e.g. FPGA) or Graphics Processing Units (GPU) using dedicated hardware or mix of software and hardware or fully in software.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 402, a transmission from a transmitting device via a transmission channel may be obtained. The transmission may conform to IEEE 802.11 protocols, such as IEEE 802.11be.

At block 404, at least one symbol included in the transmission may be identified. The at least one symbol may include multiple tones. In some embodiments, the at least one symbol may be an HE/EHT-LTF symbol.

At block 406, a first channel estimation associated with a first subset of the multiple tones may be determined. In some embodiments, the first channel estimation may be determined using over-the-air channel values of the first subset of the multiple tones.

At block 408, a second channel estimation associated with a second subset of the plurality of tones may be determined in view of the first channel estimation. In some embodiments, the second channel estimation may be determined, in part, by interpolating between values obtained as part of the first channel estimation. The interpolating may be based on the duration of the at least one symbols. Alternatively, or additionally, the second channel estimation may be determined using the interpolated values of the second subset of the plurality of tones and a digital modulation applied to the interpolated values.

At block 410, data associated with the second subset of the multiple tones may be obtained using the second channel estimation. In some embodiments, the data may be obtained by a ratio of the second channel estimation relative to the interpolated values.

Modifications, additions, or omissions may be made to the method 400 without departing from the scope of the present disclosure. For example, the designations of different elements in the manner described is meant to help explain concepts described herein and is not limiting. Further, the method 400 may include any number of other elements or may be implemented within other systems or contexts than those described.

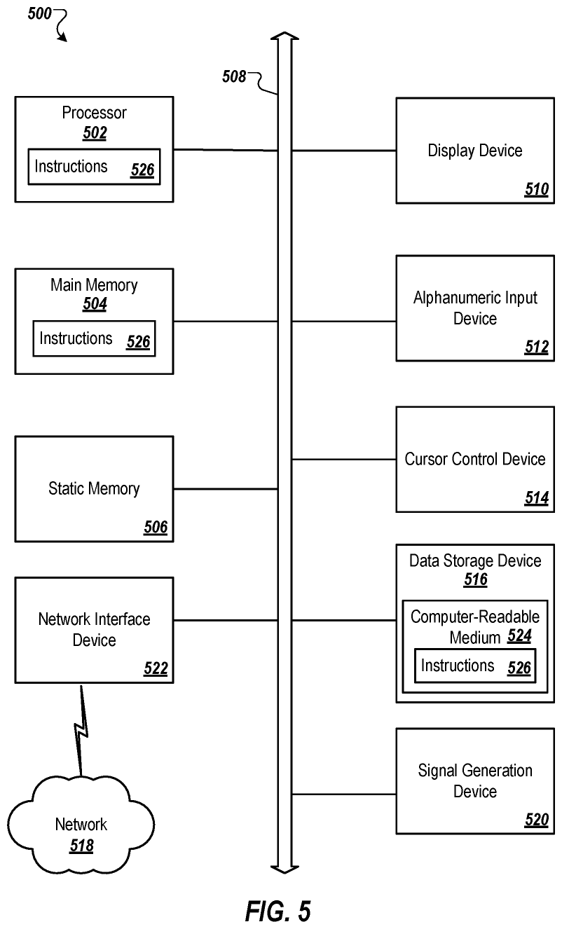

FIG. 5 illustrates a diagrammatic representation of a machine in the example form of a computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 500 includes a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

Processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one embodiment, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over a network 518 via the network interface device 522.

While the computer-readable storage medium 524 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
obtaining a transmission to be transmitted via a transmission channel;
identifying at least one symbol included in the transmission, the at least one symbol including a plurality of tones;
performing a first modulation to a first subset of the plurality of tones; and
performing a second modulation to a second subset of the plurality of tones.

2. The method of claim 1, further comprising transmitting the transmission to a receiving device using the transmission channel.

3. The method of claim 1, wherein the at least one symbol is a high efficiency/extremely high throughput-long training field (HE/EHT-LTF) symbol.

4. The method of claim 1, wherein the at least one symbol is operable to facilitate a channel estimation associated with the transmission channel by a receiving device using the first subset of the plurality of tones.

5. The method of claim 1, wherein the first modulation comprises applying a scaling factor or a phase factor to the first subset of the plurality of tones.

6. The method of claim 5, wherein the scaling factor comprises a training signal.

7. The method of claim 6, wherein the training signal includes a plurality of values associated with a particular bandwidth associated with the transmission.

8. The method of claim 1, wherein the second modulation comprises modulating the second subset of the plurality of tones with data to be transmitted to a receiving device.

9. The method of claim 8, wherein the second modulation is a binary phase shift key applied to the second subset of the plurality of tones.

10. The method of claim 8, wherein the data is included in a preamble of the transmission.

11. The method of claim 10, wherein the data in the preamble of the transmission is in lieu of including additional data in a data field of the transmission.

12. A system for wireless communication, comprising:
data processing hardware; and
memory hardware in communication with the data processing hardware, the memory hardware storing instructions that when executed on the data processing hardware cause the data processing hardware to perform operations comprising:
obtain a transmission to be transmitted via a transmission channel;
identify at least one symbol included in the transmission, the at least one symbol including a plurality of tones;
perform a first modulation to a first subset of the plurality of tones; and
perform a second modulation to a second subset of the plurality of tones.

13. The system of claim 12, wherein the operations further comprise transmit the transmission to a receiving device using the transmission channel.

14. The system of claim 12, wherein the at least one symbol is a high efficiency/extremely high throughput-long training field (HE/EHT-LTF) symbol.

15. The system of claim 12, wherein the at least one symbol is operable to facilitate a channel estimation associated with the transmission channel by a receiving device using the first subset of the plurality of tones.

16. The system of claim 12, wherein the first modulation comprises applying a training signal to the first subset of the plurality of tones.

17. The system of claim 16, wherein the training signal includes a plurality of values associated with a particular bandwidth associated with the transmission.

18. The system of claim 12, wherein the second modulation comprises modulating the second subset of the plurality of tones with data to be transmitted to a receiving device.

19. The system of claim 18, wherein the second modulation is a binary phase shift key applied to the second subset of the plurality of tones.

20. The system of claim 18, wherein the data is included in a preamble of the transmission.
